(19) United States
(12) Patent Application Publication
(10) Pub. No.: US 2016/0266752 A1
(43) Pub. Date: Sep. 15, 2016

(54) SYSTEM AND METHOD FOR EVENT DATA VISUALIZATION

(71) Applicant: Capital One Services, LLC., McLean, VA (US)

(72) Inventors: Jingtao Wu, Glen Allen, VA (US); Keelan Downton, Arlington, VA (US); Sonny Kwok, New Rochelle, NY (US); Matthew Bryan, Washington, DC (US); Colin Hart, Arlington, VA (US); Mark Mendez, Richmond, VA (US)

(73) Assignee: Capital One Services, LLC.

(21) Appl. No.: 15/068,243

(22) Filed: Mar. 11, 2016

Related U.S. Application Data
(60) Provisional application No. 62/222,951, filed on Sep. 24, 2015.
(60) Provisional application No. 62/132,479, filed on Mar. 12, 2015.

(51) Int. Cl. G06F 3/0484; G06F 9/54; G06F 17/30

(52) U.S. Cl. CPC G06F 3/0484; G06F 17/30864; G06F 9/542

(57) ABSTRACT

Systems and methods are provided for visualizing interactions between an individual and an entity such as an organization. Disclosed embodiments may include a processor configured to acquire data associated with one or more events from one or more sources, analyze the acquired data to construct a time-ordered sequence of the one or more events, and generate derived interaction information from the analyzed event data, and store the analyzed data or the derived interaction information in a structured database. The analyzed data and generated derived interaction information may be recalled and/or transmitted on-demand for use by an application or browser to construct a visualization of the events and the derived interaction information using code that represents a visual language, thereby providing a comprehensive visualization of events involving an individual and the organization in a digitized format that is easy to store, transmit, and update, while minimizing computer network burdens.

### PRIORITY CLAIM

This application claims priority from U.S. Provisional Application No. 62/132,479, filed Mar. 12, 2015, and from U.S. Provisional Application No. 62/222,951, filed Sep. 24, 2015, which are hereby incorporated by reference in the present application.

### BACKGROUND

Individuals frequently interact with organizations, especially organizations that provide services or seek to establish an ongoing relationship with customers. Interactions often include multiple types of transactions and communications with the organizations, including purchases, purchase orders, monetary transfers, telephone calls, web site visits, and electronic messages. While many interactions involve a single occurrence or event, some interactions span multiple events and stretch across multiple communications, such as dispute or complaint investigations.

When an individual experiences a problem, they usually contact the organization's customer service department, either by telephone, electronic messaging, or in-person at the organization's office. Customer service professionals are tasked with resolving the individual's problem as efficiently as possible, which often requires reviewing information of past interactions between the individual and the organization. In the presence of a customer, the customer service professional is often pressured to review the information and develop a solution quickly.

Over time, individuals amass a large quantity of interactions with the organization, which presents challenges for customer service professionals who must review information about the interactions while corresponding with the individual.

Organizations usually store information related to the interactions in multiple databases, such as a telephone call database, web server database, transaction database, etc. Some organizations compile the database information to provide textual lists of events with notes to customer service professionals. Often times, however, the customer service professional does not receive the complete record of an individual's interactions, or the presented information is limited in detail or simplicity. As a result, individuals must provide background information for the reason of their call, and multiple calls may require the individual to repeat their background information numerous times, often frustrating the individual. Furthermore, the complexity of interaction records coupled with the time-sensitive nature of customer service requests sometimes results in customer service professional confusion and frustration of the individual. Moreover, the organization's computer and network systems lose efficiency when customer service professionals must access multiple different databases and computer systems to collect information about an individual's issue, and take additional time to gather and review interaction information to develop a solution to the individual's issue.

### SUMMARY

Disclosed embodiments relate to providing a unified graphical user interface (GUI) of event data and interaction information between two or more entities, such as between an individual and an entity such as an organization. In some embodiments, one or more processors access interaction information stored across one or more networked databases, and process the stored information based on rule sets and logic to construct a graphical user interface that provides information for some or all types of interactions in a simple yet highly informative matter. Systems and methods of the disclosed embodiments provide the ability to dynamically render each individual's unique set of events using sets of rules and patterns to produce a consistent, detailed visualization designed to provide rapid understanding of the individual's experience. The resulting visualization may vary dynamically based on the information for the individual, and can change in real time as new information is collected and/or received, thereby providing a customer service representative with the latest information for the individual at the moment.

Generating pre-rendered image, chart, graph, and table files for each individual, such as in conventional visualization systems, would consume tremendous amounts of storage data, and burden computer systems when retrieving and viewing the images, charts, graphs, and tables. The disclosed embodiments overcome such complications and improve the performance of networked data visualization systems by dynamically generating the images, charts, graphs, and tables on demand. To achieve this task, the disclosed embodiments include a process of pre-populating data structures in networked databases with acquired data and data derived or generated from analyses of the acquired data. The stored acquired and derived data is recalled and processed on-demand when the interface is accessed, and is used by an application or browser to dynamically construct a visualization. The disclosed embodiments reduce computer and network loads incurred when an interested party, such as a customer service professional, accesses the GUI, because the acquired and derived data is stored together in an organized database and, therefore, individual queries to multiple separate databases are not required. Furthermore, the acquired and derived data is stored and transmitted to the browser/application in a text-based format with a minimal footprint rather than storing and transmitting prefabricated images, which require significant amounts of storage space and transmission bandwidth. Moreover, the text-based information reduces computer processor and memory loads usually created from caching large data files and rendering complex image files during transmission and display. Additionally, features of the visualizations disclosed herein enable customer service professionals to retrieve and review all information at once without requiring prolonged analysis or repeated viewings, thereby reducing system loads normally incurred from multiple data requests and transfers.

Consistent with the present embodiments, a system for event data visualization is disclosed. The system may comprise

a memory storing executable instructions and at least one processor configured to execute the stored instructions to: acquire data associated with one or more events involving an individual and an organization, analyze the acquired data to construct a time-ordered sequence of the one or more events, generate derived interaction information from the analyzed data, and generate an interactive graphical user interface on-demand, based on the acquired and derived data.

Consistent with the present embodiments, a method for event data visualization is disclosed. The method may comprise acquiring, by at least one processor, data associated with one or more events involving an individual and an organization, analyzing the acquired data to construct a time-ordered sequence of the one or more events, generating, by the at least one processor, derived interaction information from the analyzed data, and generating, by the at least one processor, an interactive graphical user interface on-demand, based on the acquired and derived data.

Consistent with other disclosed embodiments, non-transitory computer-readable storage media may store program instructions, which are executed by at least one processor device and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is an illustration of an exemplary interface for event data visualization, consistent with disclosed embodiments.

FIG. 2 is a diagram of an exemplary system environment for event data visualization, consistent with disclosed embodiments.

FIG. 3 is a diagram of an exemplary visualization server configured to perform functions of the disclosed methods, consistent with disclosed embodiments.

FIG. 4A is a flowchart of an exemplary event data acquisition and analysis process, consistent with disclosed embodiments.

FIG. 4B is a flowchart of an exemplary interface generation process, consistent with disclosed embodiments.

FIG. 5 is a flowchart of an exemplary method for generating an interactive interface, consistent with disclosed embodiments.

FIGS. 6A-6D are illustrations of exemplary interfaces for event data visualization, consistent with disclosed embodiments.

FIG. 7 is an illustration of an exemplary varying icon, consistent with disclosed embodiments.

### DESCRIPTION OF THE EMBODIMENTS

Reference will now be made in detail to exemplary embodiments, examples of which are illustrated in the accompanying drawings and disclosed herein. Wherever convenient, the same reference numbers will be used throughout the drawings to refer to the same or like parts.

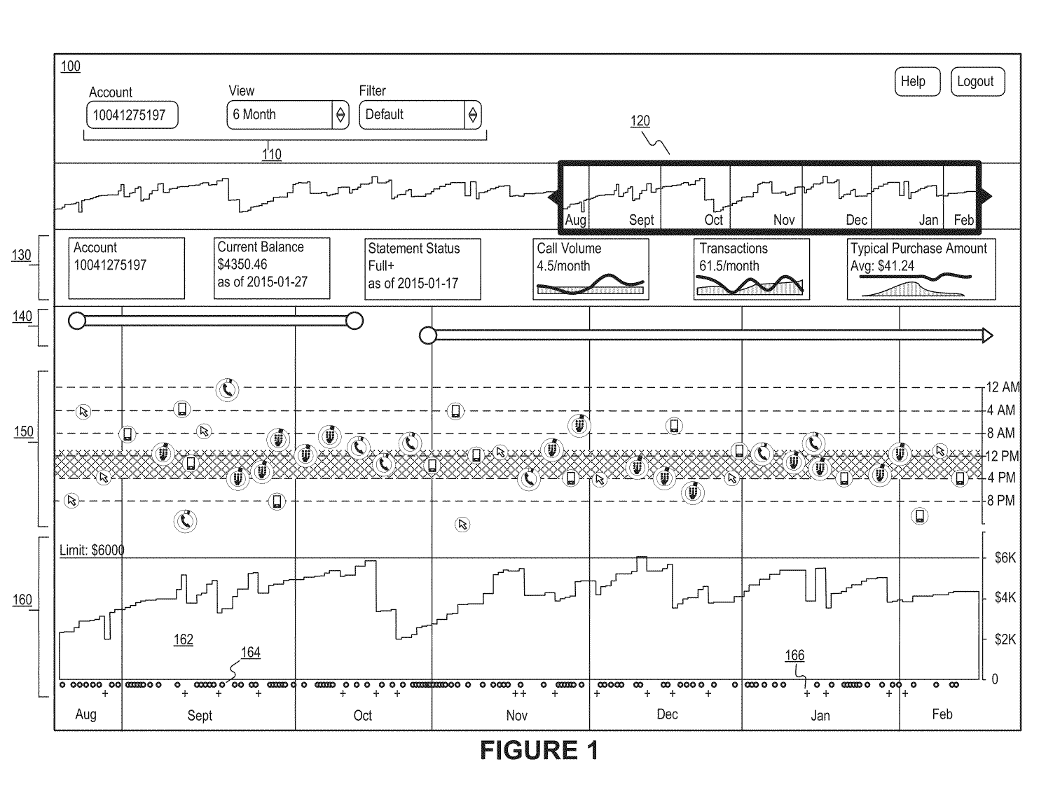

FIG. 1 is an exemplary interface for visualizing interaction information and event data, consistent with disclosed embodiments. As shown, interface 100 provides a comprehensive illustration of an individual's experience with another entity such as a particular organization over a given time period, including events relating to the organization that the individual initiated or was involved in, and/or interactions between the individual and the organization. Such events may include, for example, a transaction that the individual or the organization initiated involving an account managed by the organization, an electronic, telephonic, paper-based, or in-person communication between the organization and the individual. In some embodiments, individuals may comprise persons or entities that have previously interacted with the organization, such as a customer of the organization. For discussion purposes, individuals are described herein as customers of the organization, but the disclosed embodiments may be utilized in connection with any individual or entity capable of generating event data and interaction information. Interface 100 may arrange a plethora of information simultaneously in a single screen, allowing customer service professionals to efficiently review the events and interactions. For example, in some embodiments, interface 100 may organize different types of interactions and events involving the individual and the organization on a timeline, and visually correlate the events and interactions, such as by temporally aligning communication events with transactions, disputes, and any account information useful to a customer service professional. In some embodiments, interface 100 includes information derived from collected event data and interaction information, such as trend lines and metrics resulting from one or more analyses of collected data and information. For purposes of explanation, the terms “event data” and “interaction information” are used interchangeably herein, and generally refer to any type of occurrence involving an individual and/or an organization of which the individual is a customer. FIG. 1 is described in further detail below.

Interface 100 may provide a detailed display of static information and dynamic elements that are “interactive” and expansive in response to instructions from a viewer. For example, one or more timelines in interface 100 may provide a substantially static visual display of event data and interaction information using one or more of numbers, words, graphs, icons, and any other visual elements that effectively convey information. In response to a selection of one or more data points, interface 100 may change to provide an expanded view of details for the selected data point(s) using, for example, pop-up windows, graphical elements showing a relationship or correlation between data points, and/or a different version of interface 100 that highlights the selected data points and provides details about the selected data points.

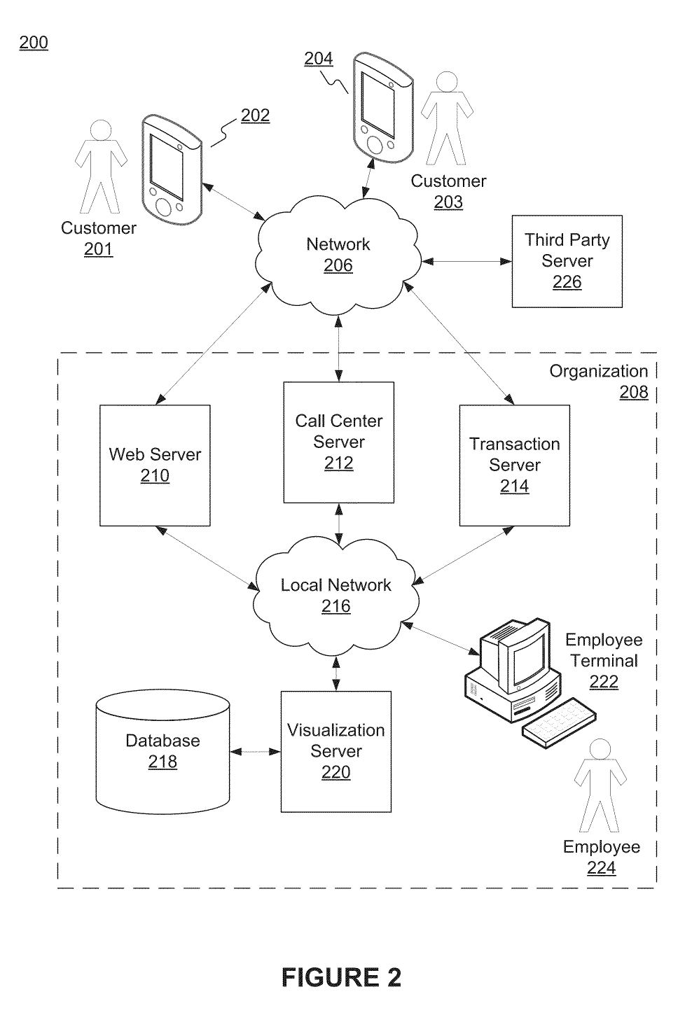

FIG. 2 is an exemplary system environment for providing individual interaction information, consistent with disclosed embodiments. As shown, system environment 200 may include customers 201 and 203, mobile devices 202 and 204, network 206, and an organization 208 including, for example, a web server 210, call center server 212, transaction server 214, local network 216, visualization server 220, database 218, employee terminal 222, employee 224, and third party server 226.

In some embodiments, customers 201 and 203 operate mobile devices 202 and 204, respectively. Mobile devices 202 and 204 can include one or more of a smartphone, general purpose computer, laptop computer, telephone, or any other device capable of communicating with network 206 and ultimately communicating with one or more components of organization 208. Customers 201 and 203 may include individuals such as, for example, subscribers, clients, prospective clients, or customers of organization 208, such as individuals who have obtained, will obtain, or may obtain a product, service, or consultation from organization 208.

Network 206 may comprise any type of computer networking arrangement used to exchange data. For example, network 206 may be the Internet, a private data network, virtual private network using a public network, and/or other suitable connection(s) that enables components in system environment 200 to send and receive information between the components of system 200. Network 206 may also include a public switched telephone network (“PSTN”) and/or a wireless network.

Third party server 226 may comprise a computer system associated with an entity, other than organization 208 and customers 201 and 203, that performs one or more functions associated with the individual and organization 208. For example, third party server 226 can comprise an automated teller machine (ATM) system that allows customer 201 to withdraw money from an account managed by organization 208. As another example, third party server 226 may comprise a server associated with a store where customer 201 intends to make a purchase using funds held in an account that organization 208 manages. As another example, third party server 226 may comprise a computer system associated with a product repair service that submits a warranty claim for a product that customer 201 purchased from organization 208.

Organization 208 may include an entity such as a business, corporation, individual, partnership, or any other entity that provides one or more of goods, services, and consultations to individuals such as customers 201 and 203. Organization 208 may include one or more servers and computer systems for performing one or more functions associated with products and/or services that organization 208 provides. Such servers and computer systems may include, for example, web server 210, call center server 212, and/or transaction server 214, as well as any other computer systems necessary to accomplish tasks associated with organization 208 or the needs of customers 201 and 203. Web server 210 may include a computer system configured to generate and provide one or more web sites accessible to customers 201 and 203, as well as any other individuals involved in organization 208's normal operations. Web server 210 may include a memory storage or database (not shown) configured to track and store information regarding interactions between customers 201 and 203 (via mobile devices 202 and 204) and web server 210.

Call center server 212 my include a computer system configured to receive, process, and route telephone calls and other electronic communications between customers 201 and 203 operating mobile devices 202 and 204, and employee 224 operating employee terminal 222. Call center server 212 may include a memory storage or database (not shown) configured to track and store information regarding interactions between customers 201 and 203 (via mobile devices 202 and 204) and call center server 212.

Transaction server 214 may include a computer system configured to process one or more transactions involving an account associated with customers 201 or 203, or a request received from customers 201 or 203. In some embodiments, transactions can include, for example, a product/service purchase, product/service return, financial transfer, financial deposit, financial withdrawal, financial credit, financial debit, dispute request, warranty coverage request, and any other type of transaction associated with the products and/or services that organization 208 provides to individuals such as customers 201 and 203. Transaction server 214 may include a memory storage or database (not shown) configured to track and store information regarding interactions between customers 201 and 203 (via mobile devices 202 and 204) and transaction server 214.

In some embodiments, transaction server 214 tracks and stores event data regarding interactions between a third party, such as third party server 226, with organization 208, on behalf of the individual. Applying the examples of third party servers 226 from above, transaction server 214 may track third party interactions such as purchase requests, refund requests, warranty claims, account withdrawals and deposits, and any other type of interaction that third party server 226 may conduct with organization 208 on behalf of an individual such as customer 201.

Local network 216 may comprise any type of computer networking arrangement used to exchange data in a localized area, such as WiFi, Bluetooth™ Ethernet, and other suitable network connections that enable components of organization 208 to interact with one another and to connect to network 206 for interacting with components in system environment 200. In some embodiments, local network 216 may comprise an interface for communicating with or linking to network 206. In other embodiments, components of organization 208 may communicate via network 206, without a separate local network 216.

Visualization server 220 may comprise one or more computer systems configured to compile data from a plurality of sources, such as web server 210, call center server 212, and transaction server 214, correlate compiled data, analyze the compiled data, arrange the compiled data, generate derived data based on the compiled data, and storing the compiled and derived in a database such as database 218. Visualization server 220 and database 218 are described in further detail below.

Employee terminal 222 may comprise one or more of a desktop computer, a laptop computer, a mobile device such as a smart phone or tablet device, and any other computerized devices configured to communicate with local network 216 to perform various functions relating to organization 208 such as, for example, receiving telephone calls and conducting teleconferences with customer 201 or 203, viewing one or more interfaces generated by visualization server 220, and any other functions associated with organization 208's products or services including analyzing individuals' data, placing orders, cancelling orders, issuing credits and refunds, processing withdrawals, deposits, and transfers, and other functions relating to products, services, or accounts associated with customer 201 or 203. Employee 224 may operate employee terminal 222, and employee 224 may comprise any individual employed by organization 208 or involved in the operations of organization 208 including, for example, a customer service professional, an account manager, a product or service manager, a clerk, etc. For discussion purposes, the employee 224 is described herein as the person who may instruct visualization server 220 to generate an interface depicting an individual's event data and interaction information. In some embodiments, customers 201 or 203 may access their own event data and interaction information via, for example, mobile devices 202 or 204, or using any other suitable computing device. In some embodiments, a person or entity other than employee 224 or customers 201 or 203 may access the event data and interaction information for an individual such as, for example, a shared account holder or a data analyst. Additionally, in some embodiments organization 208 may comprise a plurality of employee terminals 222 and employees 224, and various employee terminals 222 may serve varying functions for organization 208. As an example, a first employee terminal 222 may provide call center functions for an employee 224 performing the duties of a customer service representative. As another example, a second employee terminal 222 may provide data analytic functions for an employee 224 performing the duties of a data analyst. In both examples, the employee terminals 222 may access individuals' event data and interaction information.

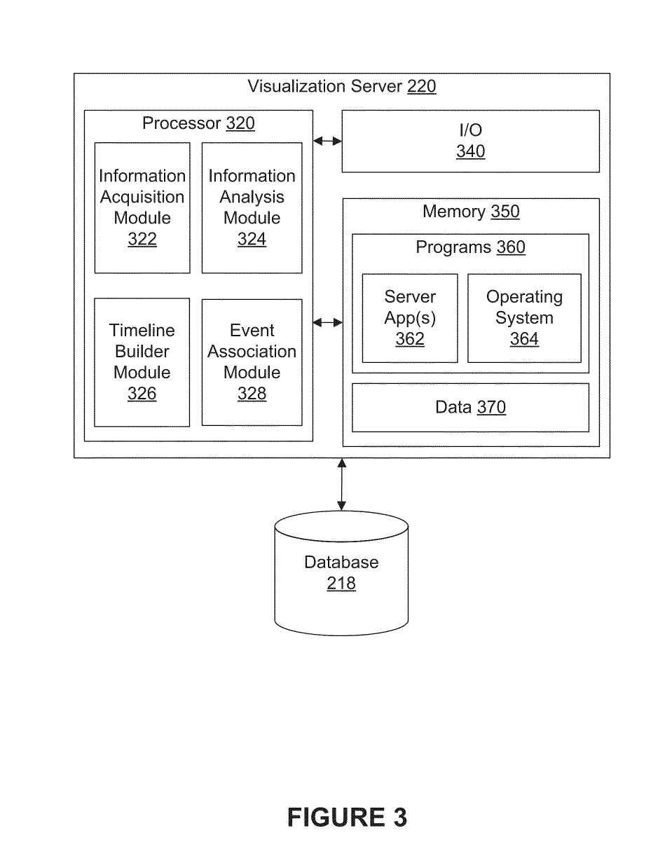

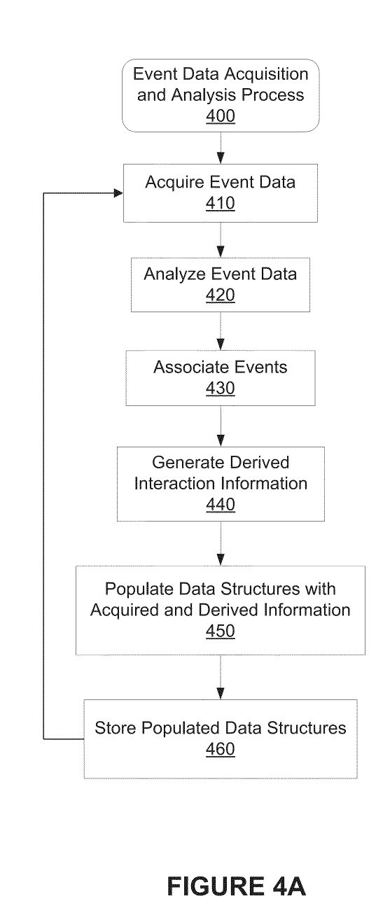

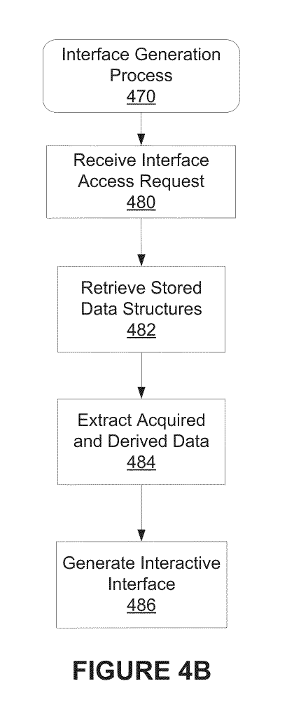

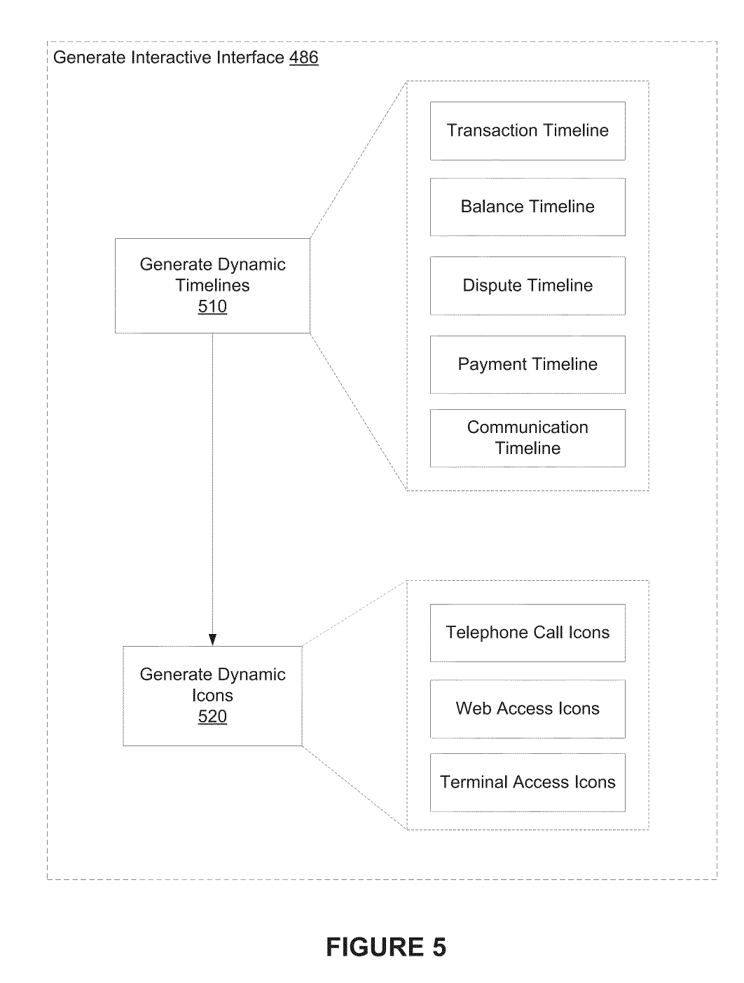

FIG. 3 shows a diagram of an exemplary visualization server 220, consistent with disclosed embodiments. As shown, visualization server 220 may include one or more processor 320, input/output (“I/O”) devices 340, memory 350 storing data 370 and programs 360 (including, for example, server app(s) 362 and operating system 364), and a database 218. Visualization server 220 may be a single server or may be configured as a distributed computer system including multiple servers or computers that interoperate to perform one or more of the processes and functionalities associated with the disclosed embodiments. In some embodiments, visualization server 220 is specially configured with hardware and/or software modules for performing functions of disclosed methods. For example, visualization server 220 may include an information acquisition module 322, an information analysis module 324, timeline builder module 326, and event association module 328. The modules can be implemented as specialized circuitry integrated within processor 320 or in communication with processor 320, and/or specialized software executable by processor 320. Functions of the modules are discussed in further detail with respect to FIGS. 4A, 4B, and 5.

Processor 320 may be one or more known or custom processing devices designed to perform functions of the disclosed methods, such as a single core or multiple core processors capable of executing parallel processes simultaneously. For example, processor 320 may be a single core processor configured with virtual processing technologies. In certain embodiments, processor 320 may use logical processors to simultaneously execute and control multiple processes. Processor 320 may implement virtual machine technologies, or other known technologies to provide the ability to execute, control, run, manipulate, store, etc. multiple software processes, applications, programs, etc. In another embodiment, processor 320 may include a multiple-core processor arrangement (e.g., dual core, quad core, etc.) configured to provide parallel processing functionalities to allow visualization server 220 to execute multiple processes simultaneously. One of ordinary skill in the art would understand that other types of processor arrangements could be implemented that provide for the capabilities disclosed herein.

Visualization server 220 may also include one or more I/O devices 340 that may comprise one or more interfaces for receiving signals or input from devices and providing signals or output to one or more devices that allow data to be received and/or transmitted by visualization server 220. For example, visualization server 220 may include interface components, which may provide interfaces to one or more input devices, such as one or more keyboards, mouse devices, and the like, that enable visualization server 220 to receive input from an employee 224 of organization 208.

Visualization server 220 may include one or more storage devices configured to store information used by processor 320 (or other components) to perform certain functions related to the disclosed embodiments. In one example, visualization server 220 may include memory 350 that includes instructions to enable processor 320 to execute one or more applications, such as server applications, an electronic transaction application, an account status application, network communication processes, and any other type of application or software known to be available on computer systems. Alternatively or additionally, the instructions, application programs, etc. may be stored in an internal database 218 or external storage (not shown) in direct communication with visualization server 220, such as one or more database or memory accessible over network 206. Database 218 or other external storage may be a volatile or non-volatile, magnetic, semiconductor, tape, optical, removable, non-removable, or other type of storage device or tangible (i.e., non-transitory) computer-readable medium.

In one embodiment, visualization server 220 may include memory 350 that includes instructions that, when executed by processor 320, perform one or more processes consistent with the functionalities disclosed herein. Methods, systems, and articles of manufacture consistent with disclosed embodiments are not limited to separate programs or computers configured to perform dedicated tasks. For example, visualization server 220 may include memory 350 that may include one or more programs 360 to perform one or more functions of the disclosed embodiments. Moreover, processor 320 may execute one or more programs located remotely from system environment 200. For example, visualization server 220 may access one or more remote programs, that, when executed, perform functions related to disclosed embodiments.

Programs 360 stored in memory 350 and executed by processor(s) 320 may include one or more server app(s) 362 and operating system 364. Server app(s) 362 may include one or more data analysis applications that cause processor(s) 320 to execute one or more processes related to aggregating and compiling data, classifying compiled data, analyzing compiled data to generate derived data including one or more of identified trends, statistics, metrics, correlations, sequences, annotations, and any other types of data that can be derived from the analyzed acquired data. In some embodiments, the derived data may include text-based data objects based on aggregated data, compiled data, statistics, and derived metrics. In some embodiments, the data objects may comprise data structures with text-based information.

In some embodiments, processor 320 may be configured to store acquired and derived data in one or more data structures of at least one database, recall the stored acquired and derived data, facilitate communication of the data, and facilitate the generation of a graphical user interface based on the data. In some embodiments, the graphical user interface may be generated by applying one or more instruction sets, rule sets, and patterns to the data. In other embodiments, processor 320 may generate code based on the acquired and stored data, comprising instructions for causing a browser to generate and display a graphical user interface. In some embodiments, server apps 362 can also include an application programming interface (API) layer designed to transfer the acquired and derived data in the data objects to one or more applications or front-end browsers, such as a desktop or mobile device browser of employee terminal 222. In such embodiments, employee terminal 222 may include a front-end software layer that stores one or more rules and definitions of visual objects associated with the acquired and derived data, to facilitate rendering of the visualization based on the acquired and derived data received from visualization server 220.

Memory 350 and database 218 may include one or more memory devices that store data and instructions used to perform one or more features of the disclosed embodiments. Memory 350 and database 218 may also include any combination of one or more relational and/or non-relational databases controlled by memory controller devices (e.g., server(s), etc.) or software, such as document management systems, Microsoft SQL databases, Share Point databases, Oracle™ databases, Sybase™ databases, or other relational databases, or non-relational databases such as key-value stores or NoSQL databases such as Apache HBase™. In some embodiments, memory 350 and/or database 218 may comprise an associative array architecture, such as a key-value storage, for storing and rapidly retrieving large amounts of information about an individual.

Visualization server 220 may also be communicatively connected to one or more remote memory devices (e.g., remote databases (not shown)) through network 206 or a different network. The remote memory devices may be configured to store information and may be accessed and/or managed by visualization server 220. By way of example, the remote memory devices may be document management systems, Microsoft SQL database, SharePoint databases, Oracle™ databases, Sybase™ databases, or other relational databases. Systems and methods consistent with disclosed embodiments, however, are not limited to separate databases or even to the use of a database.

FIG. 4A is a flowchart of an exemplary event data acquisition and analysis process, consistent with disclosed embodiments. Event data acquisition and analysis process 400 is described herein as performed primarily by visualization server 220. For example, processor 320 of visualization server 220 may perform some or all steps of process 400 via the specialized hardware and/or software of information acquisition module 322, information analysis module 324, timeline builder module 326, event association module 328, and/or the specialized software of server apps 362. It is to be understood, however, that in some embodiments another device may perform one or more steps of process 400, such as mobile device 202 or 204, or other devices (not shown in figures). In other embodiments, multiple devices may perform steps of event data visualization process 400 in a distributed-computing system including, for example, a combination of visualization server 220, web server 210, call center server 212, transaction server 214, employee terminal 222, and/or mobile devices 202 and 204.

In step 410, visualization server 220 may acquire event data from one or more storage sources including, for example, web server 210, call center server 212, and transaction server 214. Acquired data may include, for example, dates and times of individual interactions with organization 208, a type of interaction (such as telephone, web site, mobile application, electronic mail, text message, interactive voice response (IVR) interaction, ATM, via a third party, etc.), transaction details including a transaction amount, an account balance amount, transaction party information, account details, such as a credit limit or open date, dispute investigation details, including case number, summary or resolution information for a disputed transaction, call center information including a duration of a call, notes from the employee or agent, or other correspondence with an individual, a number of times the call was transferred to another employee, a hold time, and customer satisfaction ratings throughout the duration of the call, or any number of data points capable of being monitored or acquired. In some embodiments, visualization server 220 also acquires event data from one or more sources external to organization 208, such as from mobile devices 202 or 204, or from third party server 226. Visualization server may collect any and all information relevant to events associated with a product, service, or account corresponding to a particular individual, to provide the most complete visualization possible, of the individual's experience with organization 208.

In step 420, visualization server 220 may analyze the acquired event data in preparation for constructing a unified display of the event data. For example, visualization server 220 may analyze timestamps or formats of the event, data, and normalize data timestamps and formats to into a consistent data structure format. In some embodiments, visualization server 220 may identify and remove duplicative or redundant data, such as duplicate data entries received from different locations. In some embodiments, visualization server 220 may analyze identifying information in the acquired event data to ensure that all acquired data is associated with the same individual and/or same account, and to identify extraneous data that should be deleted or stored with respect to a different individual and/or account.

At the conclusion of step 420, visualization server 220 may possess a list of data objects representing the acquired event data, comprised of key-value pairs where each data object may contain a key and value for “type” and timestamp. The data objects may represent event data for each recorded event associated with the individual, and the “type” may indicate which additional values the data object will contain, such as an amount for a transaction event, a time length of a customer service call, a web page visited during a web interaction session, or any other types of recordable information associated with events. In some embodiments, visualization server 220 may add metadata to the event data, to indicate an order of each piece of event data and one or more timelines associated with each piece of event data. In some embodiments, visualization server 220 may add metadata identifying a type of timeline associated with each event in the event data such as, for example, a transaction timeline, an account balance timeline, a dispute timeline, a payment timeline, a communication timeline, and any other timelines suitable for organizing various types of acquired event data.

In step 430, visualization server may associate one or more events in the event data to create data for a “series” of events, by identifying pieces of event data that are related or linked to a common transaction and/or interaction. For example, visualization server 220 may analyze information related to each event in received event data, and determine whether multiple events identify a common transaction, such as by including a common transaction identification number, transaction amount, date/time, and any other common information in the acquired event data that could suggest a relationship between different events. As an example, visualization server 220 may detect that customer 201 accessed organization 208's web site, and made a payment within a predetermined time period, and correlate the events of accessing the web site and making the payment. Expanding upon this example, visualization server 220 may also detect that customer 201 disputed a transaction in their account, and identify the occurrence of the disputed transaction based on a transaction amount and/or transaction identification, and identify a payment made by customer 201 related to the disputed transaction. Visualization server 220 may generate and attach metadata regarding correlated events to the event data, and/or create a data structure comprising identifications of the correlated events and one or more determined relationships between the events.

As an example, visualization server 220 may generate, from the data objects generated in step 420, sequences of event data comprising key-value pairs of a key and value for “type” and timestamp, and metadata including a list of associated index numbers of related events in the timeline, to express connections between events in the timeline. The generated sequences may store searchable information such as “transactions that took place on a single day,” as well as logical connections between evens such as payments for a particular charge or account statement, followed by a phone call followed by a waived fee.

In step 440, visualization server 220 may generate derived interaction information. In some embodiments, visualization server 220 analyzes event data to detect one or more trends based on statistical analyses. In such embodiments, trends may include, for example, a period of the day and/or weekday that the individual usually interacts with organization 208, a frequency of interactions between the individual and organization 208, a preferred interaction method based on frequencies of different interaction types between the individual and organization 208, average transaction amounts, average transaction frequencies, and any other trends that visualization server 220 can derive from event data collected from multiple sources.

As an example, visualization server 220 may generate a set of key-value pairs based on the event data indicating aggregate values such as, for example, a total amount spent on the account for a given time period, or date the account was opened, or a current status such as a current balance.

In some embodiments, visualization server 220 may generate supplemental details regarding events, based on received event data. For example, event data for a telephone call may indicate that the individual was transferred to four different employees 224 during the call. Visualization server 220 may apply one or more rule sets or computer models and determine that, based on the number of transfers, the individual likely had a poor customer service experience. Thus, stored rules or models may correlate different ranges of acquired event data with metadata such as tags, labels, and pieces of data to supplement the acquired event data. Such metadata can cause visualization server 220 to generate and provide a more detailed visualization interface including assumptions, inferences, and conclusions drawn from acquired data, thereby enhancing the quality and amount of data provided to employee 224.

In step 450, visualization server 220 may create one or more database entries in a structured database with the acquired event data and derived information. In some embodiments, visualization server 220 may create a textual-based database entry that conforms to a predetermined data structure associated with the event data including acquired data, processed data, statistics, and any other derived information. The data structures may include one or more of the acquired event data, derived interaction information, types of timelines that should be generated, and relationships between events. In some embodiments, visualization server 220 may create a single data structure for all acquired event data and derived information associated with an individual and/or an account. In other embodiments, visualization server 220 may create multiple data structures, such as data structures for different time periods or data structures for different event data types.

In some embodiments, visualization server 220 may store a database or library of visual language information such as computer code (not shown in figures) associated with visual templates and graphical elements for instructing a processor to generate and display certain types of visual elements for the data in the data structures, such as timelines, icons, and other visual objects useful for presenting event data. Visual language information may include code for visual elements included in a common visual language and framework for interpreting the code and constructing a visualization interface. In some embodiments, the framework may comprise an application that interprets visual language information representing event data for one or more events, and representing the event data using symbols, shapes, lines, and positions that communicate both an identity of the event and specific details regarding the event.

In some embodiments, visualization server 220 may store one or more sets of rules and instructions for rendering each event type in a specific, consistent way (step not shown in figures). For example, visualization server 220 may store instructions for assigning different types of events or series in the acquired and derived data to different icons or shapes. Upon execution of the stored instructions, a computer such as visualization server 220 may generate one or more icons, shapes, or structured combinations of icons and shapes corresponding to events, the sequences of events, and any other types of data in the stored acquired and derived data.

In some embodiments, the created data structures may include information associated with one or more layers of details to display in a visualization interface. For example, a first layer may provide general details regarding events illustrated in a predominantly pictorial manner. A second layer may include text-based details for particular events that are revealed as pop-up boxes or windows in the visualization interface, when employee 224 selects a particular event. In some embodiments, different types of events may be separated into different layers, such that employee 224 can toggle and filter different types of events to be displayed simultaneously in the visualization interface. For example, telephone call event data and web site access event data may be separated in separate layers, allowing employee 224 to view both event types simultaneously or view individual event types.

As an advantage of the disclosed embodiments, the generated data structures including text-based acquired and derived data may utilize minimal storage space, and can be transferred over a network more efficiently than pre-generated image files. Additionally, the data structures can be processed quickly and efficiently by a receiving device to create and display the visualization interface, rather than an inefficient process of transmitting raw data which must be processed, and analyzed on-demand. In some embodiments, data structures can be interpreted and utilized by an application for generating a visualization.

In step 460, visualization server 220 may store the created data structures having the acquired and derived data in database 218 and/or memory 360. In some embodiments, database 218 may comprise an associative array for storing and retrieving large volumes of data efficiently, such as a key-value storage system.

Process 400 may then return to step 410, and visualization server 220 may continue to acquire new event data in real-time as new events occur.

FIG. 4B is a flowchart of an exemplary interface generation process 470, consistent with disclosed embodiments. Process 470 may begin in step 480, when visualization server 220 determines that a request for access to the visualization interface is received. The request may be received from employee 224 such as, for example, a customer service professional, a data analyst, an account manager, or any other interested party, from a device such as employee terminal 222. After visualization server 220 determines that a request for the stored data structures is received, in step 482 visualization server 220 may retrieve stored data structures associated with the received request, and extract the acquired and derived data from the retrieved data structures. In step 484, visualization server 220, or a processor in communication with visualization server 220, may execute one or more applications for generating an interactive visualization interface based on the extracted acquired and derived data. Employee terminal 222 may serve as a portal for viewing and/or interacting with the generated interactive interface, to allow employee 224 to view an individual's comprehensive experience with organization 208.

In some embodiments, one or more applications for generating the interactive visualization interface may reside on employee terminal 222. In such embodiments, in step 482 visualization server 220 may retrieve stored data structures and transmit the data structures or the extracted acquired and derived data to employee terminal 222 (step not shown), for generating the visualization interface on employee terminal 222.

Referring again to step 486, visualization server 220 may generate an interactive visualization interface by rendering visual elements including graphs, charts, timelines, icons, and any other visual elements that effectively convey information in an easy-to-understand manner. In some embodiments, visualization server 220 may apply one or more framework algorithms comprised of rules, patterns, and logic for interpreting the acquired and derived data, and rendering graphical depictions of the visual elements including graphs, charts, timelines, icons, labels, etc., where the visual elements reflect values of the data in the data structures. For example, visualization server 220 may match a data type for a telephone icon in the acquired and derived data to instructions or rules describing how the telephone icon should appear on a computer display. Visualization server 220 may also determine a correct position for each visual element based on values in the data structures including, for example, a timestamp, event type, and a value associated with the event such as a transaction amount or a telephone call duration.

FIG. 5 is a flowchart of an exemplary method for generating an interactive interface (step 486), consistent with disclosed embodiments. FIG. 5 is provided for illustration purposes only, and visualization server 220 may perform step 486 with additional or fewer steps, based on the types of event data acquired, the needs of organization 208, and the needs of individuals such as customers 201 and 203. As previously discussed, in some embodiments step 486 is performed using a computing device other than visualization server 220, such as employee terminal 222 and, in some embodiments, using mobile devices 202 or 204.

In step 510, visualization server 220 may generate one or more dynamic timelines based on stored data structures. In some embodiments, visualization server analyzes each data structure for each type of timeline, and generates a time-ordered visual depiction of event data based on the acquired and derived data in the database structures, and one or more sets of predetermined rules. Visualization server 220 may create one or more of a transaction timeline, notes timeline, balance timeline, dispute timeline, payment timeline, investigation timeline, communication timeline, or one or more other types of timelines, depending on the types of event data acquired for the individual, and the types of data derived from the acquired data. It is to be understood that the types of information illustrated in FIG. 5 are mere examples, and that the disclosed embodiments may acquire, analyze, and visualize other types of information depending on the needs of the organization or users. Visualization server 220 may align multiple timelines on a common time axis, to display information regarding different events such as transactions and communications in a unified and comprehensive timeline. In some embodiments, visualization server 220 may generate a miniature version of one or more of the timelines to allow a viewer, e.g. employee 224, to select a time period of an individual's history to view in an expanded and detailed view.

In some embodiments, visualization server 220 may generate various timeline visualizations with different styles, colors, and/or layouts. In such embodiments, organization 208 may store instructions including a predefined set of rules for visualization settings for different types of event data. Visualization server 220 may attach these instructions as metadata to acquired and/or derived data during process 400. When executed, the instructions can direct at least one processor to generate visualizations such as a stepped bar graph, line graph, scatter plot, and any other type of visual statistical representation suitable for presenting data to employee 224, based on the needs of organization 208, employee 224, and/or customers 201 and 203.

In step 520, visualization server 220 may generate one or more dynamic icons based on certain types on event data. In some embodiments, visualization server 220 may store rules for determining which event data types are visualized using icons, and visualization server 220 may attach metadata to the event data, event sequence (series) data, and/or other derived data, indicating a type and layout of icon to generate for various event data types. In some embodiments, visualization server 220 may generate icons for interactions between an individual such as customer 201 and organization 208, or an interaction between third party server 226 (on behalf of customer 201) and organization 208. In such embodiments, visualization sever 220 may generate telephone call icons representing phone interactions between an individual and organization 208, web access icons representing the individual's interaction with organization 208's web site, mobile app icons representing the individual's interaction with a mobile app offered by organization 208, IVR interaction icons representing the individual's voice and/or touch-tone interaction with a computerized voice response system operated by organization 208, terminal access icons representing the individual's interaction with a terminal such as an ATM to perform transactions (not shown), payment icons representing a payment that organization 208 receives from the individual, icons indicating a failed or declined transaction, charge icons representing a charge to the individual's account initiated and/or authorized by the individual, withdrawal and deposit icons representing additions or deductions to the account, dispute icons representing individual's interaction with organization 208 to dispute a transaction, and any other icons suitable for presenting event data in a visual timeline.

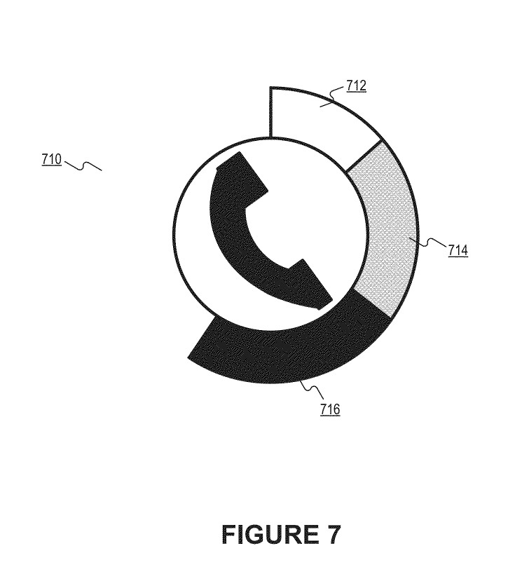

In some embodiments, visualization server 220 may generate icons comprising a simple image representing the event type. In some embodiments, visualization server 220 may generate icons that vary based on details in acquired event data. These varying icons are discussed in further detail with respect to FIG. 7.

Returning to FIG. 1, as shown, interface 100 includes one or more elements such as search and filter options 110, mini timeline 120, account statistics section 130, dispute timeline 140, interaction timeline 150, and balance timeline 160. In some embodiments, interface 100 may include additional or fewer elements, depending on the needs of employee 224 viewing the interface, organization 208, and/or the individual such as customer 201. In some embodiments, interface 100 may include one or more dynamic icons, graphs, and other visual elements representative of the events and series of events in the acquired and derived data. Interface 100 may also include one or more graphs, statistics, or metrics associated with determined trends or summaries of the acquired and derived data. As shown in the figures and described herein, interface 100 is created and displayed based on acquired and derived data for one customer 201. In some embodiments, however, interface 100 may include controls for identifying multiple individuals such as multiple customers 201, and visualization server 220 may generate a single unified interface 100 reflecting the acquired and derived data of the multiple selected customers 201.

Search and filter options 110 may include one or more input fields and/or selectable options for searching for an individual's account number and/or account name, selecting a length of a period of time to display in interface 100, and/or filtering the amount and types of information displayed. For example, employee 224 may wish to view only telephone interactions between customer 201 and organization 208, and employee 224 can filter the event types displayed to show only certain types of event icons, such as telephone icons. In some embodiments, additional or fewer filter options may allow employee 224 to customize types of information displayed on interface 100 based on the needs of employee 224, organization 208, and/or customer 201. For example, filter options may allow a user, such as employee 224, to toggle the display of certain types of data, and selectively hide other types of data. In some embodiments, interface 100 may include one or more selectable preset filter sets having one or more predefined filters. Such filter sets may be associated with different business groups of an organization or different themes, to display information most relevant to the theme or most commonly utilized for the particular business group. In some embodiments. Interface 100 may allow the user to create customized filter sets, and save the customized filter set for later use. Interface 100 may also allow for selection of a predetermined number of recently-used filter sets.

Mini timeline 120 may comprise a miniature version of one or more of the timelines displayed in interface 100. Mini timeline 120 may serve as a “scroll bar” for scrolling through different periods of time in customer 201's experience with organization 208. In some embodiments, mini timeline 120 may include a moveable window for selecting a time period to display in interface 100. The time period length selected by the moveable window may be altered by input from employee 224, such as by clicking and dragging either end of the movable window, or by selecting a different time period length in search and filter options 110.

Account statistics section 130 provides data and trends regarding customer 201's account such as, for example, the account number, timestamped balance, statement status and statement date, monthly average call volume, monthly average transactions, and average purchase/transaction amount. In some embodiments, account statistics section 130 may provide one or more trend graphs corresponding to the one or more trend statistics, and may include a trend line specific to the individual displayed with one or more graphs of the same trends for a population of individuals. For example, in FIG. 1 the individual has a varying trend line of call volumes over the six-month time period displayed in interface 100, and an average call volume of 4.5 calls to organization 208 per month. With the varying trend line is a shaded graph of the statistical average call volume trends for a population of individuals, which may include all customers of organization 208 or a subset of all customers. As shown, the population trend of call volume is represented by a relatively flat trend graph, compared to the individual's waving trend line.

Dispute timeline 140 includes one or more icons and visual depictions of disputes initiated by customer 201 and/or organization 208. For example, dispute timeline 140 may include an initiation point representing the date and/or time at which customer 201 or organization 208 filed a dispute, such as disputing a transaction associated with the account. A bar may extend horizontally from the initiation point across the timeline, and terminate at a resolution point representing the date and/or time at which the dispute was resolved and the matter closed. As shown in FIG. 1, a first dispute was initiated near the beginning of the time period displayed, and resolved shortly after. Another dispute was initiated around the middle of the time period displayed, and is not resolved, as indicated by the bar extending to the end of the timeline and without any resolution point. Visualization server 220 may provide additional details regarding the disputes and identify all events associated with the dispute, in response to selection of the dispute initiation or resolution points. Additional information may be displayed in the form of a popup window, a different interface, and/or additional symbols, lines, and other visual elements.

Interaction timeline 150 includes a time-ordered depiction of interactions between customer 201 and organization 208 including, for example, web site visits, mobile app uses, telephone calls, IVR interactions, and other forms of communication not depicted in FIG. 1 such as automated teller machine (ATM) transactions, office visits, letters, and electronic mail. In some embodiments, icons for electronic mail may represent communications transmitted to and from an individual from the organization. Interaction timeline 150 may include one or more dynamically-generated icons that indicate the type of communication, and may visually indicate details about particular communications. For example, telephone call icons may include a color-coded status bar around the icon, indicating duration of a phone call as well as other information such as a number of times customer 201's call was transferred, hold times, and/or customer 201's demeanor during the call. In some embodiments, telephone call icons may serve as active links to one or more databases that store recorded information such as a telephone call recording associated with the telephone call icon. In some embodiments, icons representative of website visits may serve as active links to one or more databases that store recordings of an individual's activities on a website associated with the organization. For example, if the organization records customer activity on their website, selecting the web site visit icon may cause display of a video playback of the customer's sequence of clicks and data entry on the website, or provide a log of activities associated with the timestamp of the web site visit icon. Visualization server 220 may analyze notes and comments, and either generate one or more visual representations associated with the notes and comments, or include the notes and/or comments as details displayed in a popup window upon selecting (e.g., clicking or hovering) on/over a corresponding event.

In some embodiments, interaction timeline 150 may include a vertical time axis, and indicate a time of day at which each of the interactions occurred. Visualization server 220 may determine, based on the interaction timestamps, a preferred time period for contacting customer 201, based on customer 201's patterns of interacting with organization 208. In some embodiments, visualization server may analyze both (i) customer 201—initiated activities and (ii) organization 208—initiated activities, but give customer 201—initiated activities a higher weighting to reflect customer 201's choice in time for contacting organization 208. In the example shown in FIG. 1, a horizontal shaded bar appears between 11 AM-4 PM on interaction timeline 150, indicating that customer 201 usually prefers to interact with organization 208 between 11 AM-4 PM. The shaded bar may vary depending on the indicated activities of the selected time frame. For example, if a different time frame (different months or length of time) is selected, visualization server 220 may dynamically calculate a new preferred time period based on the activities of the newly-selected time frame. The shaded bar may be directly proportional to the amount of activity for the time frame. In some embodiments, the shaded bar may represent a standard deviation or a high confidence interval corresponding to the amount of individual activity. In some embodiments, interface 100 may include multiple bands of different shading to indicate different confidence values or standard deviations.

Balance timeline 160 provides a visualization of customer 201's account balance graph (162), transaction icons (164), and payment icons (166). In some embodiments, balance timeline 160 may include additional icons and elements to indicate credits, deposits, withdrawals, adjustments, and any other changes to customer 201's account balance (not shown in figure). Balance graph 162 may include a visualization such as a bar graph or line graph indicating changes in an account balance over the time period displayed. Balance graph 162 may correspond directly to the portion of mini timeline 130 within the movable window. Transaction icons 164 may correspond to charges incurred on customer 201's account. In some embodiments, transaction icons 164 may represent various types of transactions, and details of a particular transaction may appear upon selection of a particular transaction icon 164. Payment icons 166 may correspond to payments made by customer 201 to organization 208, thus decreasing the account balance depicted by balance graph 162.

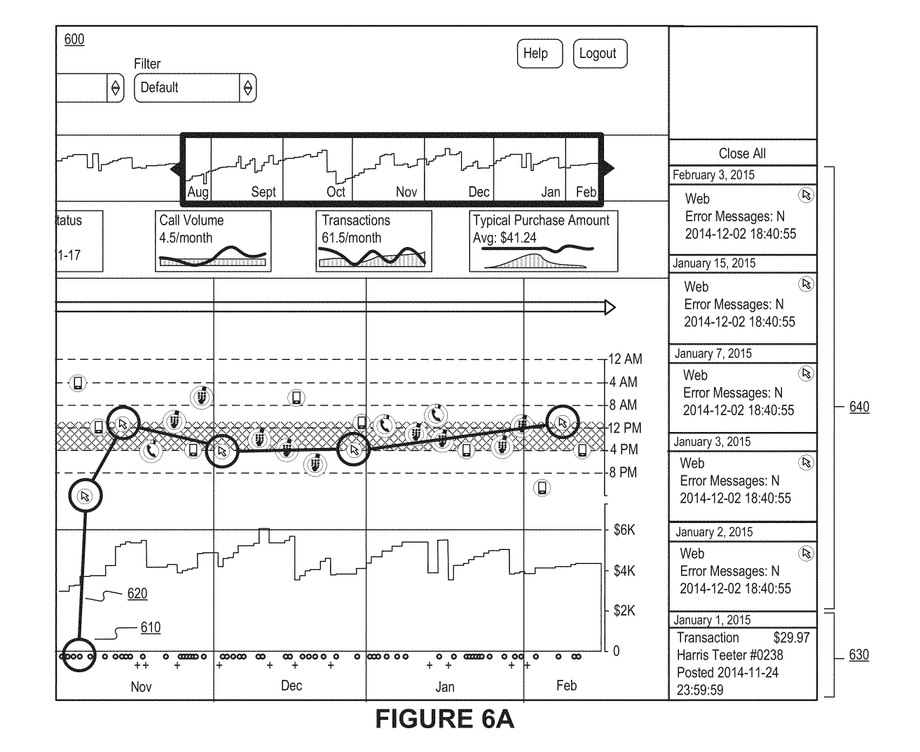

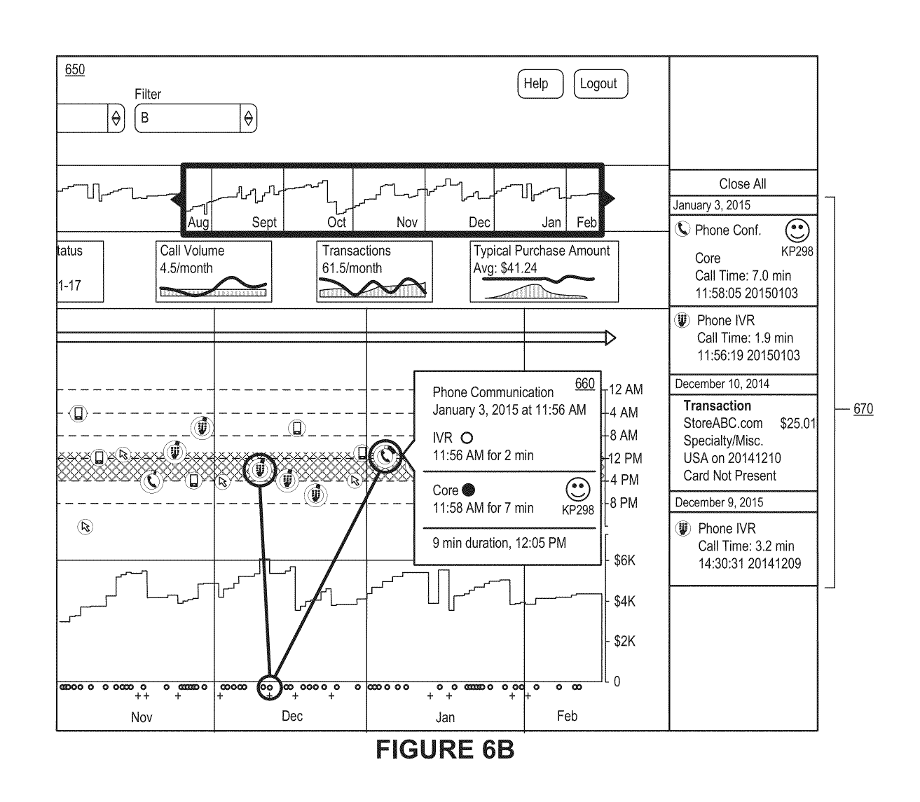

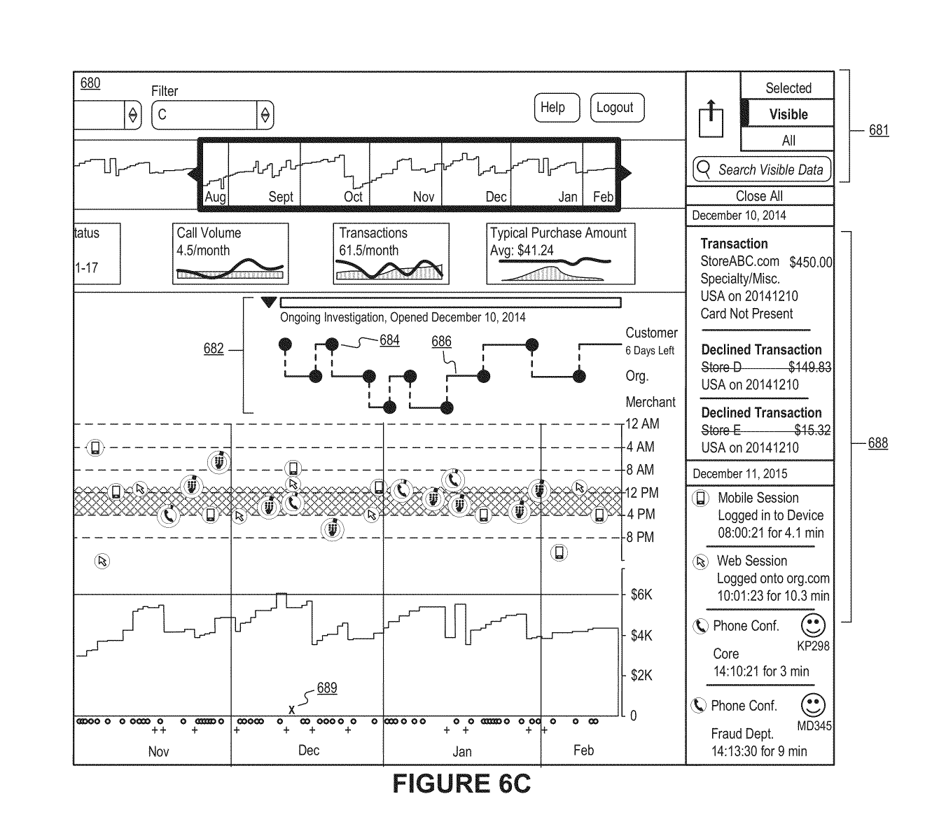

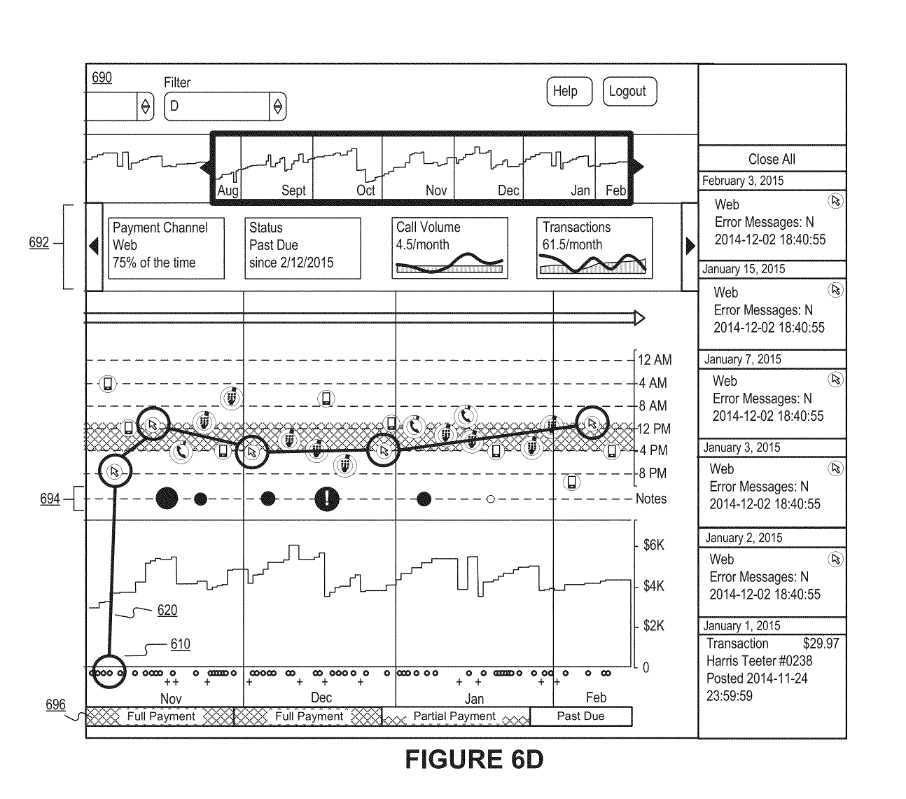

Selecting visual elements in interface 100, such as by clicking a visual element or “hovering” a mouse cursor over a visual element, may reveal deeper levels of detail and information about the event. In some embodiments, selection of a visual element such as a dispute initiation point may cause a display of determined associated events and derived interaction information generated by process 400, and described in further detail with respect to FIG. 6A-D.

FIG. 6A is another illustration of an exemplary visualization interface. FIG. 6A illustrates event detail interface 600, generated based on previously-generated derived interaction information and identified associated events. The exemplary event detail interface 600 visualizes associated events as a linked chain, with additional details for each associated event shown on the side of the interface. In the example shown, an event associated with transaction icon 610 is selected, by clicking or hovering a mouse cursor over the transaction icon 610. Event detail interface 600 provides a visualization of all events and interactions associated with the selected transaction icon 610. Associated events are connected and emphasized by lines and circles 620. As shown, lines and circles 620 identify five events corresponding to customer 201 accessing organization 208's website and inquiring about the selected transaction. In some embodiments, visualization server 220 may automatically identify the five associated events by detecting web activity related to the transaction underlying transaction icon 610, such as detected web activity of clicking on the underlying transaction ID, transaction amount, and any other web activity or information that links web activity for different events to the transaction underlying transaction icon 610. In some embodiments, visualization server 220 may continuously improve logic for automatically detecting associated events based on analysis of manual inputs and historical indications of acceptance or rejection of automatic identifications.

In some embodiments, detail interface 600 may include a popup window or detail display of the selected event, such as detail window 630 showing detailed information for the transaction underlying transaction icon 610. Associated event detail windows 640 may also appear in event detail interface 600, to illustrate details for customer 201's web activity associated with the selected event. In some embodiments, the associated events may include various types of events, such as web access, mobile access, telephone, calls, etc. Employee 224 may filter the displayed associated events using search and filter options 110 (shown in FIG. 1), to focus the displayed information on a particular type of event/interaction.

FIG. 6B is another illustration of an exemplary visualization interface. FIG. 6B illustrates event detail interface 650, generated based on previously-generated derived interaction information and identified associated events. As shown, interface 650 may include one or more pop-up window 660 and a sidebar 670. Interface 650 may provide a first layer of information about events in the acquired and derived data, using basic elements or icons to show what channel the event took place in, how long the event lasted, and how many interactions took place on that event (or how many events were in a series). Selection of an icon or element, such as by clicking or hovering over the icon with a cursor, may cause visualization sever 220 to generate one or more pop-up windows 660 to show additional corresponding details for the event(s) associated with the selected icon. In some embodiments, selection of an icon or group of icons may cause display of the additional information in the sidebar 670 area, to provide the viewer with an additional layer of detail to and to tell a complete story of customer 201's experience.

For example, as shown in FIG. 6B, selecting a telephone call icon may cause visualization server 220 to generate information for displaying popup window 660. Popup window 660 may include additional details about the telephone call, and the types of information displayed may vary based on the amount of data stored for the telephone call, the types of fields in the stored data structure, and the rules and processing logic determined based on the needs of the organization and/or the viewer. As shown in the example of FIG. 6B, pop-up window 660 includes information such as the type of event (telephone communication), the date and time, and the duration of each segment of the call, along with a legend corresponding to the icon. As shown, the first segment of the call was an IVR interaction that lasted for two minutes, and is represented by the white portion of the dynamic ring around the telephone icon. The second segment of the call was a discussion with the call center core group, lasted for seven minutes, and is represented by the black portion of the dynamic bar around the telephone call icon. In some embodiments, pop-up window 660 may also include an identification and/or picture of the organization 208 employee 224 that participated in the second segment of the call; in this example employee 224 “KP298” spoke for seven minutes with customer 201. Pop-up window 660 may also indicate the total length of the call and the ending time.

In some embodiments, icons may be selectable via mouse “clicks,” hovering a cursor over the icon for a predetermined period of time, or gestures detected by a touch-sensitive device or a gesture-recognition device. Selection may cause display of one or more pop-up windows with information associated with the selected icon. In some embodiments, icons may serve as links to additional information stored in database 218 or stored elsewhere. For example, selection of an icon may cause display of additional details including acquired or derived information stored in database 218, as discussed above. In some embodiments, selection may cause visualization server 220 to request and retrieve data from another database (not shown), such as a telephone call recording associated with the selected telephone call icon. In such embodiments, the telephone call icon may act as a link to the other database. In some embodiments, selection of an icon may cause a computer other than visualization server 220 to retrieve and provide the associated information.

FIG. 6C is another illustration of an exemplary visualization interface. FIG. 6C illustrates event detail interface 680, generated based on previously-generated derived interaction information and identified associated events. As shown, in some embodiments, interface 680 may include sidebar controls 681, investigation details 682 including at least one node 684 and line 686, sidebar 688, and decline icon 689.

Sidebar controls 681 may include one or more selectable buttons, toggle switches, or other type of control element to allow employee 224 to customize the displayed information. In some embodiments, employee 224 may toggle between displaying a list of detailed information for events that are currently selected, events that are currently visible on the interface 680 (as opposed to off-screen), or all events. As shown, events that are currently “visible” in interface 680 are selected for display in sidebar 688, and the scrollable list of events in sidebar 688 may be limited to the events displayed on interface 680. In this example, events associated with nodes 684 of investigation details 682 are selected, and the detailed list in sidebar 688 is associated with those selected events.

In some embodiments, sidebar controls 681 may include one or more buttons for exporting or sharing interface 680. Selection of the one or more buttons may cause visualization server 220 to begin a process of printing, emailing, or exporting interface 680 to a computer file such as a PDF or image file.

In some embodiments. sidebar controls 681 may include a search query field, to allow employee 224 to input a search string. Based on the input search string, visualization server 220 may search the events selected in the sidebar controls 681, such as “selected,” “visible,” or “all.” Such controls may assist employee 224 to perform a targeted search through a subset of acquired and derived data, or a wide search over a wide range of acquired and derived data.

Investigation details 682 may include a region of interface 680 generated in response to selection of a single graphical element. In the example shown, a horizontal bar in a dispute timeline can be selected, causing visualization server 220 to dynamically modify interface 680 with a display of nodes 684 representing the events associated with the selected dispute, and lines 686 that connect the nodes 684. In some embodiments, nodes 684 themselves may be selectable icons, and selection of one or more nodes 684 may cause visualization server 220 provide one or more types of detailed secondary information. The detailed information may appear in a popup window overlaid on the interface, in sidebar 688 of interface 680, or in any other type of interface portion or window that is easy to read.

In some embodiments, selection of a graphical element that represents a series of events may cause visualization server 220 to generate information for displaying an expanded and detailed view of the events in the series. FIG. 6C shows an example of a user interface 680 with an expanded view of a series. As shown, a series of events on the dispute timeline is selected via selection of an expansion arrow in the horizontal bar representing the length of the investigation, resulting in an expanded view with investigation details 682. Investigation details 682 may include multiple events associated with a dispute investigation as a graphical chart, by portraying both the temporal sequence of events and the actor associated with each event. In the example shown, the expanded dispute view is displayed with three levels of nodes 684 for events: customer, organization, and third party. In some embodiments, the third party may be a merchant at which customer 201's account was used to attempt or complete one or more transactions, and the account is managed by the organization. In some embodiments, interface 680 may automatically display a list of the events in a portion of the interface. For example, the events relevant to the investigated dispute may be displayed in sidebar 688 in temporal order, with details about each event, to provide employee 224 with a story of the series of events. Lines 686 may illustrate a relationship between at least two nodes 684 for events in the series. For example, visualization server 220 may generate information for connecting the elements for each event with graphical elements such as solid and dashed lines, based on an analysis of the series and event data. As shown, solid lines may indicate the length of time that an actor's action or response was pending, and dashed lines may connect events from different actors to indicate the sequence of events and communications between actors in the series. In some embodiments, visualization server 220 may generate information for displaying one or more popup windows or other forms of additional information displays when a user selects or hovers a mouse cursor over a graphical element associated with an event in the series.

In some embodiments, interface 680 may include a time-ordered, scrollable, and/or searchable list of events corresponding to the events in the selected series. In the example shown, sidebar 688 is provided with details for each displayed event in the selected series. Details for each event may include, for example, a type of event, an identification of employee 224 or a merchant associated with the event, a transaction amount for the event, an indication of a status of the event (such as “declined,” or “approved,” or strikethrough text), a location of the event, a date and/or time stamp of the event, an icon associated with the event, and any other information relevant to the event that is included in the acquired and derived data. In some embodiments, details shown in sidebar 688 may include an identification number for each event or documents associated with the event. In some embodiments, details in sidebar 688 may include a department name, telephone call or event length.

As shown in FIG. 6C, transactions in the transaction timeline include at least one declined transaction, which is identified by decline icon 689, and reflected in sidebar 688 with both a “declined transaction” label and strikethrough formatting for the merchant and transaction amount.

FIG. 6D is another illustration of an exemplary visualization interface. FIG. 6D illustrates event detail interface 690, generated based on previously-generated derived interaction information and identified associated events. As shown, interface 690 may include summary region 692, notes timeline 694, and payment status timeline 696. In some embodiments, summary region 692 may include one or more controls for scrolling across multiple summary metrics and trend graphs. As shown, summary region 692 may include one or more items such as, for example, a payment channel, a payment status, call volume, and transactions. Other types of summary metrics and trend graphs are illustrated in FIGS. 6A-6C.

In some embodiments, a payment channel box may indicate customer 201's most-used mechanism for paying outstanding balances. As shown, the payment channel may indicate that customer 201 pays balances using a web interface 75% of the time, as opposed to other payment methods like checks, in-person payments, or telephone payments. Visualization server 220 may dynamically determine the payment summary information based on the time frame selected for display on interface 690. In some embodiments visualization server 220 may determine payment channel information during process 400, and store metrics about customer 201's payment methods during a predetermined time period, or for the entire tenure of customer 201's relationship with organization 208.

In some embodiments, a payment status box may indicate a real-time status of customer 201's outstanding balance. In the example shown, a payment has been past due since Feb. 12, 2015. In some embodiments, interface 690 may also display a history of payment statuses in payment status timeline 696.

In some embodiments, visualization server 220 may receive one or more notes input notes from an individual such as employee 224, in some embodiments, notes may originate from customer or from a third party authorized to view and use interface 690.

In some embodiments, interface 690 may notes timeline 694. Notes timeline 694 may include one or more notes icons to indicate the presence of one or more notes input by an individual such as employee 224 or, in some embodiments, customer 201. The icon may indicate the date that the note was created, based on its placement in the timeline. In some embodiments, visualization server 220 may generate an icon having a customized appearance based on attributes of each note. For example, an icon may have a size that is directly proportionate to a number of words or characters that in the note. In the example shown, icons in notes timeline 694 vary in size, were longer notes are represented with larger icons compared to shorter notes that are represented with smaller icons. In some embodiments, visualization server 220 may change the appearance of one or more note icons based on an analysis of notes for an indication of importance, such as by detecting certain words or phrases of predetermined importance, or one or more priority flags attached to notes. As shown in FIG. 6D, one or more icons in notes timeline 694 may vary in color, or include an indication of high priority such as an exclamation point.

In some embodiments, notes associated with one or more events may cause one or more icons in interface 690 to change appearance (not illustrated in figures). For example, when employee 224 annotates an event with notes, the icon associated with that event may change color or size, such as by changing to a color that distinguishes the icon from others of the same type, or a larger size than other icons that have fewer or no annotations.

FIG. 7 is an illustration of an exemplary varying icon. As shown in FIG. 7, varying icon 710 can identify a type of event, and additional dynamic details about the event. In the illustrated example, varying icon 710 represents a telephone call, such as a customer service call between customer 201 and organization 208. In some embodiments, varying icon 710 may include one or more visual indicators of details about an associated event. For example, status bars 712, 714, and 716 may illustrate details about the event, to convey information to employee 224 quickly and without the need to read numbers and lists of textual information. In the example shown, status bar 712 may represent a time length that customer 201 was placed on hold before a customer service professional answered the call. Status bars 714 and 716 may indicate different portions of the telephone conversation with different customer service professionals. Again, the length of each status bar may indicate the duration of the call portion, and a color or shading pattern of each status bar may indicate customer 201's presumed agitation level. For example, if a telephone call is transferred numerous times to different customer service professionals, the customer raised his/her voice, the customer used certain words or phrases, etc., visualization server 220 may presume that such events resulted in agitation or dissatisfaction, and visualization server 220 may generate visual language information and data structures that cause display of a varying icon 710 having multiple status bars of increasing color intensity, to alert employee 224 of the customer's likely agitation or dissatisfaction. Thus, the disclosed embodiments can provide detailed information about individual events quickly and effectively, even in visualization interfaces that include a multitude of icons displaying many events.

It is not exhaustive and is not limited to the precise forms or embodiments disclosed. Modifications and adaptations of the embodiments will be apparent from consideration of the specification and practice of the disclosed embodiments. For example, the described implementations include hardware, firmware, and software, but systems and methods consistent with the present disclosure can be implemented as hardware alone. Furthermore, although the embodiments are described with respect to the events and interactions of an individual or a single customer, the disclosed embodiments may provide visualizations for groups of individuals or populations. Additionally, the disclosed embodiments can generate and display timelines of any types of events in an effective manner, and implementations of the disclosed embodiments are not limited to the examples discussed herein.

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a computer system, non-transitory computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

What is claimed is:

1. A system for event data visualization, comprising
a memory storing executable instructions; and
at least one processor configured to execute the stored instructions to:
acquire data associated with one or more events involving an individual and an organization;
analyze the acquired data to construct a time-ordered sequence of the one or more events;
generate derived interaction information from the analyzed data; and
generate an interactive graphical user interface on-demand, based on the acquired and derived data.

2. The system of claim 1, wherein the at least one processor is further configured to:
store, in a networked database, the analyzed data and the derived interaction information;
receive a request for the data associated with one or more events; and
transmit the stored analyzed data, and the derived interaction information to a device associated with the request.

3. The system of claim 2, wherein the analyzed data and the derived interaction information cause an application in the device to construct the visualization of the one or more events and the derived interaction information.

4. The system of claim 1, wherein the processor generates one or more of visual timelines, icons, or trend graphs of the acquired and analyzed data.

5. The system of claim 1, wherein the at least one processor is further configured to identify one or more events in the acquired data that are associated with a common experience, and generate derived interaction information based on the identified events.

6. The system of claim 1, wherein the acquired data comprises one or more text-based data structures.

7. The system of claim 1, wherein the at least one processor is further configured to detect a user input, and generate at least one popup window based on the user input.

8. A method for visualizing event data, comprising
acquiring, by at least one processor, data associated with one or more events involving an individual and an organization;
analyzing the acquired data to construct a time-ordered sequence of the one or more events;
generating, by the at least one processor, derived interaction information from the analyzed data; and
generating, by the at least one processor, an interactive graphical user interface on-demand, based on the acquired and derived data.

9. The method of claim 8, further comprising:
storing, in a networked database, the analyzed data and the derived interaction information;
receiving a request for the data associated with one or more events; and
transmitting the stored analyzed data and the derived interaction information to a device associated with the request.

10. The method of claim 9, wherein the analyzed data and the derived interaction information cause an application in the device to construct the visualization of the one or more events and the derived interaction information.

11. The method of claim 8, wherein the processor generates one or more of visual timelines, icons, or trend graphs of the acquired and analyzed data.

12. The method of claim 8, further comprising:
identifying one or more events in the acquired data that are associated with a common experience; and
generating derived interaction information based on the identified events.

13. The method of claim 8, wherein the acquired data comprises one or more text-based data structures.

14. The method of claim 8, wherein the processor detects a user input, and generates at least one popup window based on the user input.

15. A non-transitory computer readable medium having stored instructions which when executed cause at least one processor to perform a method for visualizing event data, comprising acquiring, by at least one processor, data associated with one or more events involving an individual and an organization;
analyzing, by the at least one processor, the acquired data to construct a time-ordered sequence of the one or more events;
generating, by the at least one processor, derived interaction information from the analyzed data; and
generating, by the at least one processor, an interactive graphical user interface on-demand, based on the acquired and derived data.

16. The non-transitory computer readable medium of claim 15, the method further comprising:
storing, in a networked database, the analyzed data, and the derived interaction information ;
receiving a request for the data associated with one or more events; and
transmitting the stored analyzed data and the derived interaction information to a device associated with the request.

17. The non-transitory computer readable medium of claim 16, wherein the analyzed data and the derived interaction information cause an application in the device to construct the visualization of the one or more events and the derived interaction information.

18. The non-transitory computer readable medium of claim 15, wherein the at least one processor generates one or more of visual timelines, icons, or trend graphs of the acquired and analyzed data.

19. The non-transitory computer readable medium of claim 15, further comprising:
identifying one or more events in the acquired data that are associated with a common experience; and
generating derived interaction information based on the identified events.

20. The non-transitory computer readable medium of claim 15, wherein the acquired data comprises one or more text-based data structures.
